(19) United States
(12) Patent Application Publication
(10) Pub. No.: US 2008/0077562 A1
(43) Pub. Date: Mar. 27, 2008

(54) System and Method for Relating Ratings by Entities to Associations among the Entities

(76) Inventor: Leonard Dylan Schleppe, Austin, TX (US)

Correspondence Address: Giorgos A. Georgakis;Chowdhury & Georgakis, PC, PO BOX 90277, AUSTIN, TX, 78709-0277, US

(21) Appl. No.: 11/534,607

(22) Filed: Sep. 22, 2006

(51) Int. Cl. G06F 17/30

(52) U.S. Cl. 707/3; 707/1

(57) ABSTRACT

Systems and methods for relating provider ratings by entities to associations among the entities. In one embodiment, a request may be received by a requesting entity for a provider rating; a search for existing provider ratings by other entities may be performed; and the existing provider ratings may be provided to the requesting entity in response to finding existing provider ratings. The request may be sent to one or more recipient entities having a particular association to the requesting entity; and the provider rating may be provided to the requesting entity in response to receiving the provider rating from one of the recipient entities.

### I. BACKGROUND

The invention relates generally to the field of association-based ratings.

### II. SUMMARY

In one respect, disclosed is a method for relating provider ratings by entities to associations among the entities. The method may further comprise: receiving a request by a requesting entity for a provider rating; searching for existing provider ratings by other entities; and providing the existing provider ratings to the requesting entity in response to finding existing provider ratings. The method may further comprise: sending the request to one or more recipient entities having a particular association to the requesting entity; and providing the provider rating to the requesting entity in response to receiving the provider rating from one of the recipient entities.

In another respect, disclosed is an information handling system comprising: one or more memory units; one or more input/output units; and one or more processors, the system being operable to: relate provider ratings by entities to associations among the entities. The system may be further operable to: receive a request by a requesting entity for a provider rating; search for existing provider ratings by other entities; and provide the existing provider ratings to the requesting entity in response to finding existing provider ratings. The system may be further operable to: send the request to one or more other entities having a particular association to the requesting entity; and provide the provider rating to the requesting entity in response to receiving the provider rating from one of the recipient entities.

In yet another respect, disclosed is a computer program product stored on a computer operable medium, the computer program product comprising software code being effective to: relate provider ratings by entities to associations among the entities. The code may be further effective to: receive a request by a requesting entity for a provider rating; search for existing provider ratings by other entities; and provide the existing provider ratings to the requesting entity in response to finding existing provider ratings. The code may be further effective to: send the request to one or more recipient entities having a particular association to the requesting entity; and provide the provider rating to the requesting entity in response to receiving the provider rating from one of the recipient entities.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a flow diagram illustrating a method for relating provider ratings by entities to association among the entities, in accordance with one embodiment.

FIG. 2 is a flow diagram illustrating a method for searching for a provider rating requested by an entity and optionally forwarding the request to other entities, in accordance with one embodiment.

FIG. 3 is a flow diagram illustrating a method for adding a provider rating by an entity, in accordance with one embodiment.

FIG. 4 is a flow diagram illustrating a method for determining admission of an entity to a group in the system for the purpose of providing or requesting provider ratings, in accordance with one embodiment.

FIG. 5 is a block diagram showing a memory unit operable to store provider ratings by entities and associations among the entities, in accordance with one embodiment.

FIG. 6 is a block diagram showing an information handling system operable to relate provider ratings by entities to associations among the entities, in accordance with one embodiment.

FIG. 7 is a flow diagram illustrating a method for updating keywords in response to keyword searches and subsequent responses, in accordance with one embodiment.

FIG. 8 is a flow diagram illustrating a method for showing advertisements accompanied by corresponding ratings, in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

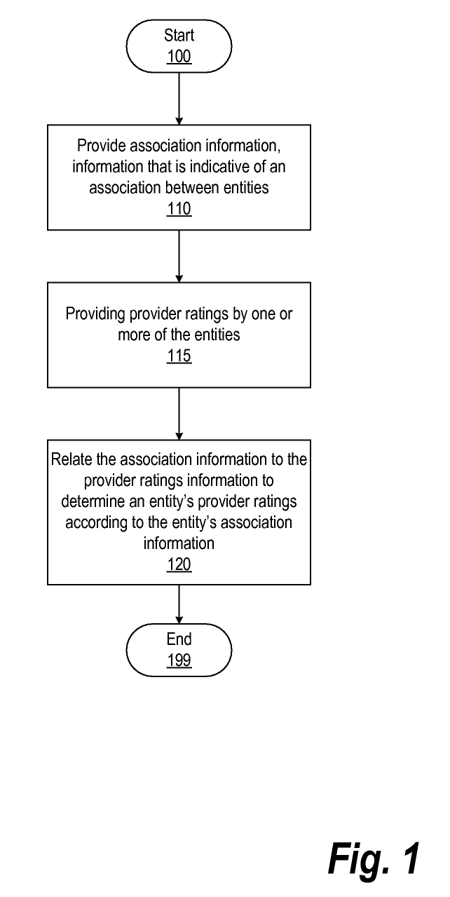

FIG. 1 is a flow diagram illustrating a method for relating provider ratings by entities to association among the entities, in accordance with one embodiment. Processing begins at 100 whereupon, at block 110, association information is provided, the information being indicative of an association between entities. An entity as used herein can be a person, a legal entity (such as a corporation, a partnership, etc.), a group of people, a group of legal entities, a combination of the above, etc.

An association among entities can be one multiple relationships. Two entities may be associated, for example, because they belong to the same neighborhood association, they graduated from the same college, they attend the same church, etc. Two legal entities may be associated because they operate in the same field, for example. An association may also exist between two entities because the two entities have indicated a friendly relationship between them or a certain degree of trust among them. An entity may have multiple types of associations.

At block 115, provider ratings information by one or more of the entities. Provider as used herein may indicate a provider of services, a provider of products, or a provider of services and products. Thus, a provider rating may indicate an overall performance for the provider. For example, a provider rating for a mechanic may indicate how good or bad a mechanic is generally. It should be noted, however, that provider rating as used herein may also indicate ratings for particular services or products. For example, the mechanic may be rated with respect to how well the mechanic can repair transmissions or how well the mechanic can repair brakes.

At block 120, the association information is related to the provider ratings to determine an entity's provider ratings according to the entity's association information. By relating provider ratings to entity associations, provider ratings can be provided to entities according the entities' associations.

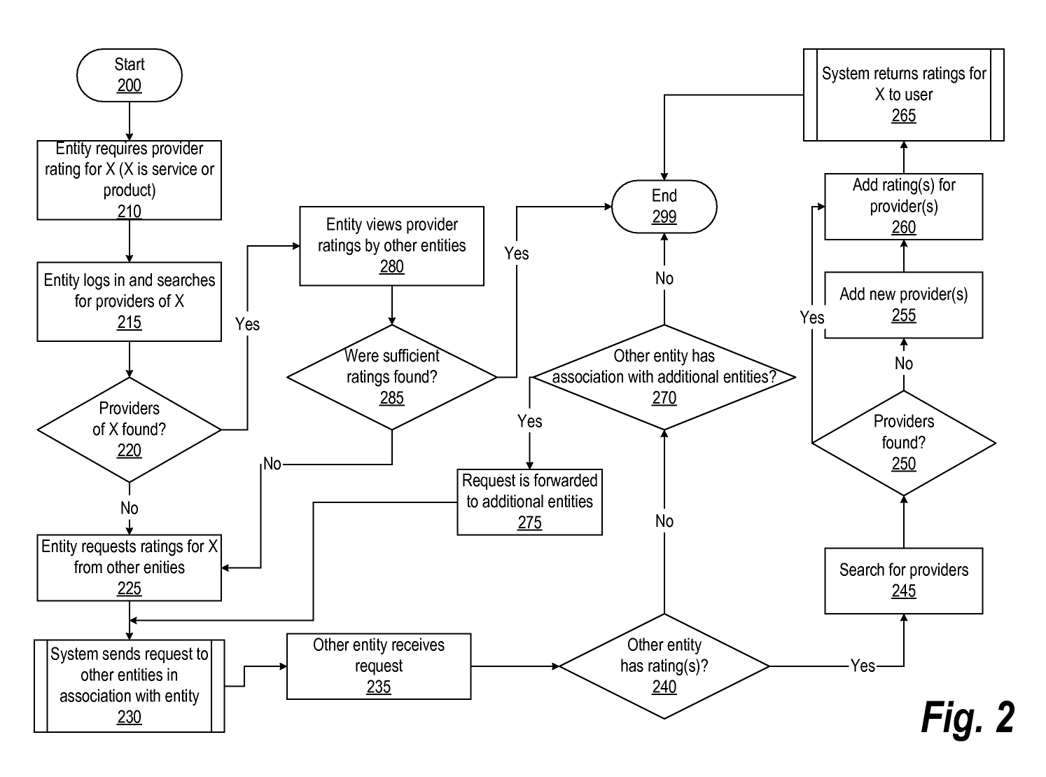

FIG. 2 is a flow diagram illustrating a method for searching for a provider rating requested by an entity and optionally forwarding the request to other entities, in accordance with one embodiment.

Processing begins at 200 whereupon, at block 210, an entity requires a provider rating for a particular service or product. For example, the entity may require a provider rating for a plumbing service. At block 215, the entity logs into the system and searches for plumbing service providers. In one embodiment, the system may be accessed through a web browser. The system may also be accessed through a variety of other devices, media, and interfaces such as telephones, mobile phones, PDAs, pagers, etc.

At decision 220, a determination is made as to whether any providers were returned by the search. If providers are found, decision 220 branches to block 280 where the entity views the provider ratings returned by the search. At decision 285, a determination is then made as to whether sufficient provider ratings were returned by the search (i.e., whether the entity is satisfied by the results of the search). If sufficient provider ratings were not found, decision 285 branches to block 225. Otherwise, decision 285 branches to 299 where processing ends.

Returning to decision 220, if no providers were returned by the search, decision 220 also branches to block 225 where, in one embodiment, the entity requests provider ratings from other entities. In response thereto, the system, at block 230, sends the request to other recipient entities. In one embodiment, the system only forwards the request to other entities with which the requesting entity has an association. For example, the system may forward the request only to other entities having a first degree friendship with the requesting entity.

At block 235, another entity receives the request for a provider rating. Processing then continues at decision 240 where a determination is made as to whether the other entity has provider ratings that match the request. If the other entity does not have the appropriate provider ratings, decision 240 branches to decision 270. On the other hand, if the other entity has the appropriate provider ratings, decision 240 branches to block 245 where the system searches to determine an entry for the particular provider(s) exists in the system.

At decision 270, a determination is made as to whether the other entity has an association with additional entities and desires to forward the request to those additional entities. If the other entity does not have additional associations, decision 270 branches to 299 where processing ends. Otherwise, decision 270 branches to block 275 where the request is forwarded to these additional entities. Processing then loops back to block 230 where the forwarded request is processed.

At decision 250 a determination is made as to whether entries for the provider(s) already exist in the system. If entries for the provider(s) do not exist, decision 250 branches to block 255 where the new providers are added. On the other hand, if the providers already exist, decision 250 branches to block 260 bypassing block 255. At block 260, the provider ratings are added to the system.

At block 265, the system returns the additional provider ratings to the requesting entity. In addition, the ratings may also be made available to the other entities that responded to the requesting entity. Processing then ends at 299.

In one embodiment, the system may permit an entity to view ratings from other entities (including the detailed, subjective comments entered by those entities) with which the entity has a particular association.

In one embodiment, when forwarding a request, an entity may be given a choice as to which other entities to forward the request.

The system stores and indexes the various providers by different categories and also associates keywords with each provider to facilitate quick searching and locating of providers by the entities.

In one embodiment, the system is also operable to automatically update the keywords associated with a particular provider. For example, the requesting entity may enter keywords in connection with the forwarding of the request for a rating. The response by another entity to the request recommending a particular provider, for example, is an implicit indication by the other entity that those keywords match the particular provider. Thus, the information on that particular provider may now be updated with those keywords.

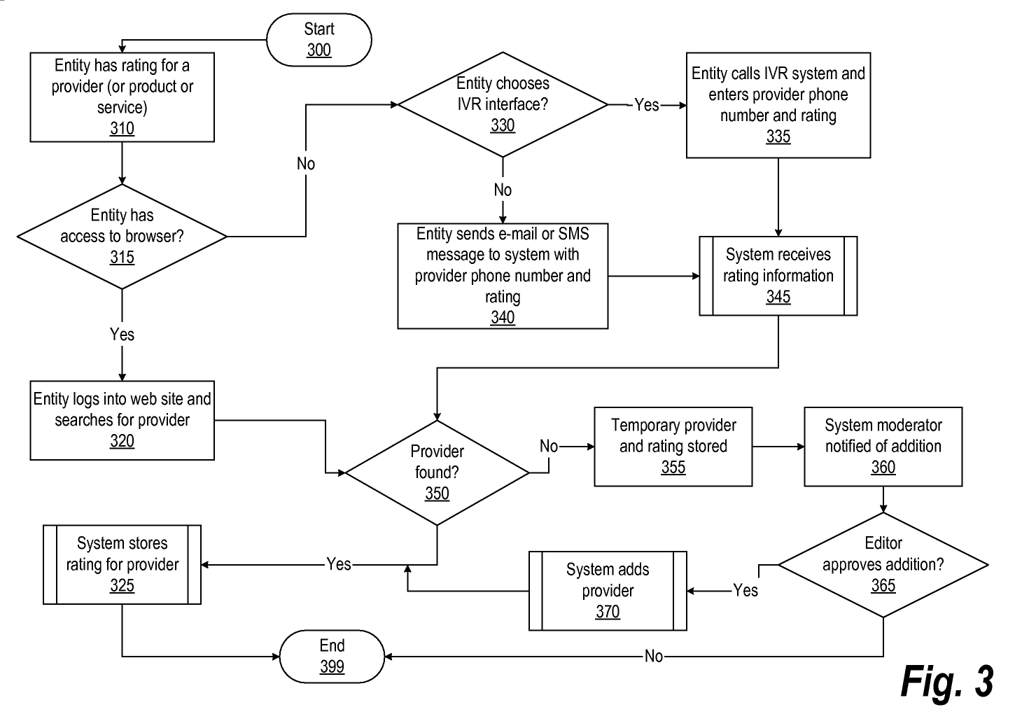

FIG. 3 is a flow diagram illustrating a method for adding a provider rating by an entity, in accordance with one embodiment. Processing begins at 300 whereupon, at block 310, an entity wishes to register a provider rating. At decision 315, a determination is made as to whether the entity has access to a browser. If the entity has access to a browser, decision 320 branches to block 320 where the entity logs into the website and searches to determine whether an entry for the particular provider already exists. In one embodiment, the entity may log in using a username and a password. Other authentications methodologies (such as fingerprint or retinal scanning) may be used as well. In another embodiment, the entity may be identified using a passive method such as caller ID information, for example. Processing subsequently continues at decision 350.

If the entity does not have access to a browser, decision 315 branches to decision 330 where a determination is made as to whether the entity wishes to use an interactive voice response (IVR) interface, which is a telephone-based system with prompts guiding a user through the various options. If a user wishes to use the IVR interface, decision 330 branches to block 335 where the entity calls the IVR system and through the system enters the provider and the rating for the provider.

In one embodiment, the provider may be identified by having the user enter the provider's telephone number. Other methods may also be used, such as the user entering a particular code corresponding to a particular provider. In one embodiment, the provider may be identified using the location of the provider. The entity may, for example, enter the provider's address. Alternatively, the location of the provider may be determined automatically using a GPS locator, for example, in the entity's mobile phone, PDA, or GPS device. The location provided may be cross-referenced against providers and their locations in a database to determine the provider corresponding to that location. Processing subsequently continues at decision 350.

Alternatively, if the entity does not wish to use the IVR interface, decision 330 branches to block 340 where the entity sends the provider rating to the system using an alternative method such as e-mail, SMS, instant messaging, etc. Processing then continues at block 345.

At decision 350, a determination is made as to whether an entry exists for the provider. If an entry for the provider exists, decision 350 branches to block 325 where the system stores the provider rating. Processing subsequently ends at 399. On the other hand, if an entry for the provider is not found, decision 350 branches to block 355 where a temporary entry for the provider and the rating are stored in the system.

At block 360, a system moderator may be notified of the temporary entry, and at decision 365, a determination is made as to whether the system moderator approves the addition. If the system moderator does not approve the addition, decision 365 branches to 399 where processing ends.

If, on the other hand, the system moderator approves of the provider addition, decision 365 branches to block 370 where the system adds the provider to the existing list of providers. Subsequently, processing continues at 325 where the associated rating is also added to the system.

In an alternative embodiment, when an entity enters a new provider that is not in the system, the provider's data is either automatically or manually entered in the system for possible selling or advertising. In one embodiment, the provider's data is stored in a temporary state. An e-mail, for example, may then be sent to the provider informing the provider that an entity entered their contact information in the system and other entities can now enter ratings of that business. The e-mail may also invite the provider to visit the system's website or to call a number to find out more about the marketing services provided. In one embodiment, advertisements may be placed by the provider which may accompanied by the rating(s) for that particular advertiser.

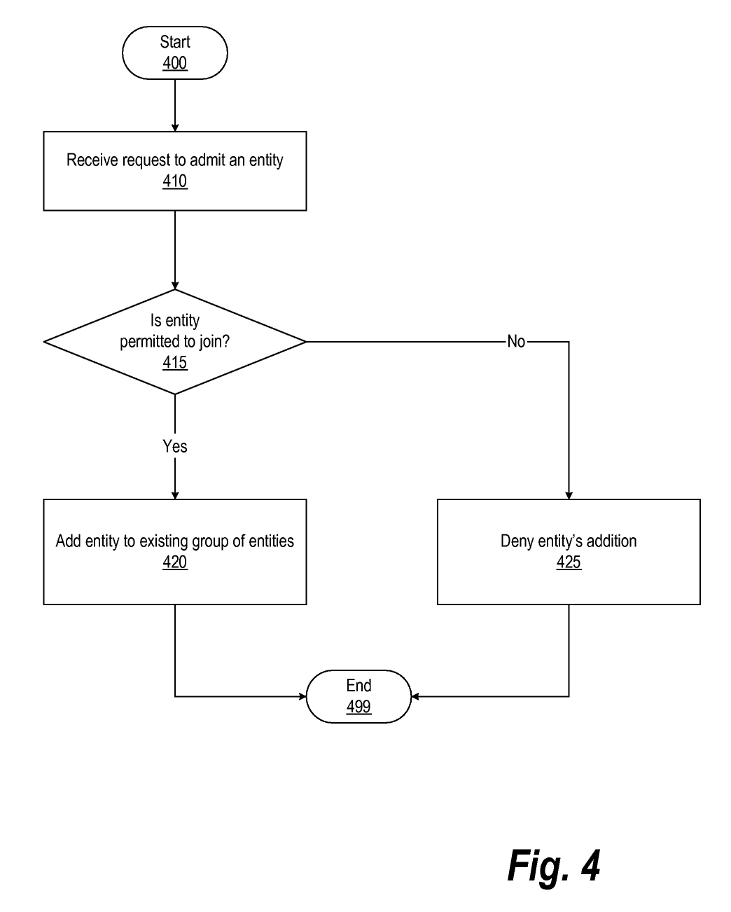

FIG. 4 is a flow diagram illustrating a method for determining admission of an entity to a group in the system for the purpose of providing or requesting provider ratings, in accordance with one embodiment. Processing begins at 400 whereupon, at block 410, a request for admission by an entity is received. In one embodiment, an entity may receive a request from an existing entity to become a member.

A determination is then made, at decision 415, as to whether the entity is to be given membership. Membership requirements can vary significantly depending on the type of membership requested. For example, if membership is based on friendship, an entity will be permitted to join only if the entity has an invitation by a friend who is an existing member. If membership is based on belonging to a social group, for example, an entity will permitted to join only after the entity's membership to the social group is verified.

If the entity is to be permitted to join, decision 415 branches to block 420 where the entity is added to the system. In addition, additional data is added in relation to the entity information, indicating to which group the entity belongs and in which capacity. For example, friendship relationships may be indicated in the system. Processing subsequently ends at 499.

On the other hand, if the entity is not to be permitted to join, decision 415 branches to block 425 where the entity is denied membership. Processing subsequently ends at 499.

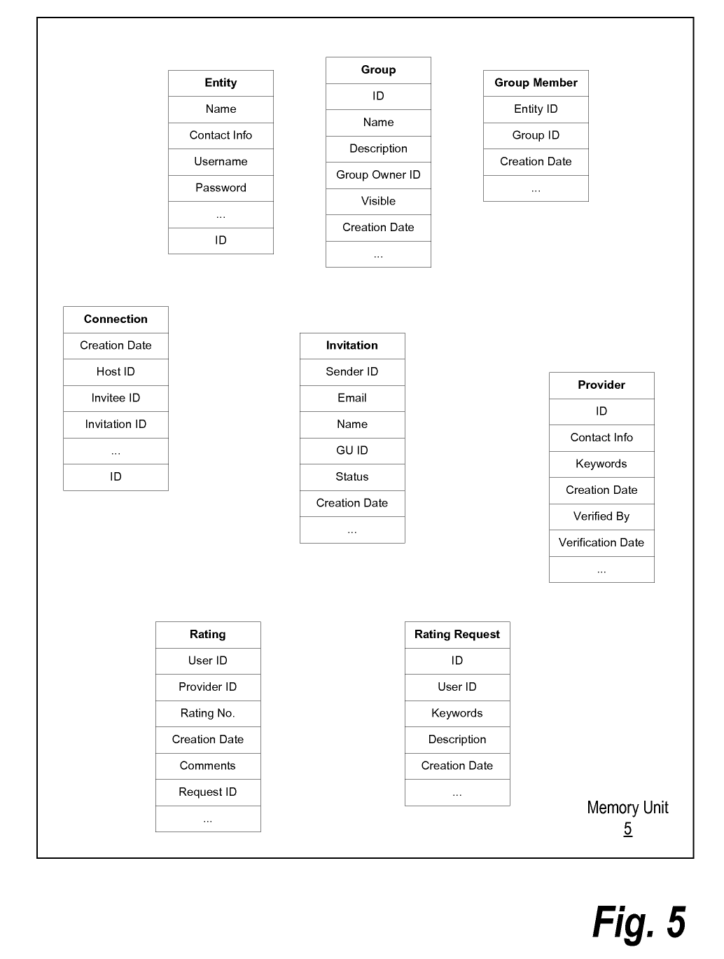

FIG. 5 is a block diagram showing a memory unit operable to store provider ratings by entities and associations among the entities, in accordance with one embodiment. FIG. 5 shows only one example of how data may be structured and stored in the system.

An entity data table may be used to store information on different entities, which may include among other fields, a unique ID identifying each entity, the name of the entity, contact information for the entity, and authentication information for the entity such as a username and a password.

A group data table may be used to represent the group to which entities can belong. Among other fields, the group may include a unique ID, a name, a brief description, a group owner ID (identifying the entity/moderator responsible for the group), a visible field indicating whether the group is visible to other entities, and a creation date.

A group member data table may be used to represent associations between groups and entities. Each entry may represent an entity/group pair. Among other fields, the group member table may include the entity ID for the pair, the group ID for the pair, and a creation date.

A connection table may be used to represent connections made to the system by an entity. Among other fields, the connection may include a unique ID, a creation date, a host ID (indicating the origin of the connection, such as a telephone number, an IP address, etc.), an invitee ID indicating the entity that was invited to participate, and an invitation ID indicating the specific invitation with which the connection is associated.

An invitation table may be used to represent the invitation that may be sent from one entity to another. Among other fields, the invitation table may include the sender's ID (entity sending the invitation), the e-mail and name of the person sending the invitation, a Globally Unique Identifier (or GU ID, which is used as a security mechanism to preserve the uniqueness of each invitation and to prevent unauthorized invitations), the status of the invitation (whether it has been accepted), and the invitation's creation date.

A provider table may be used to store the various providers in the community. Among other fields, the provider table may include a unique ID, the provider's contact info (such as phone number, address, website, etc.), keywords to facilitate better searching capabilities, a creation date, a verified by entry indicating which moderator approved the entry, and a verification date.

A rating table may be used to represent the various provider ratings. Among other fields, the ratings table may include a user ID field indicating the entity that provided the rating, a provider ID indicating the provider associated with the rating, a creation date, comments by the entity that provided the rating, and a request ID if any indicating whether the rating was entered in response to a request by another entity.

A rating request table may be used to represent rating request from one entity to another. Among other fields, the rating request table may include, a unique ID, a user ID indicating the entity requesting the rating, a description of the service or product, keywords to better identify the service or product, and a creation date.

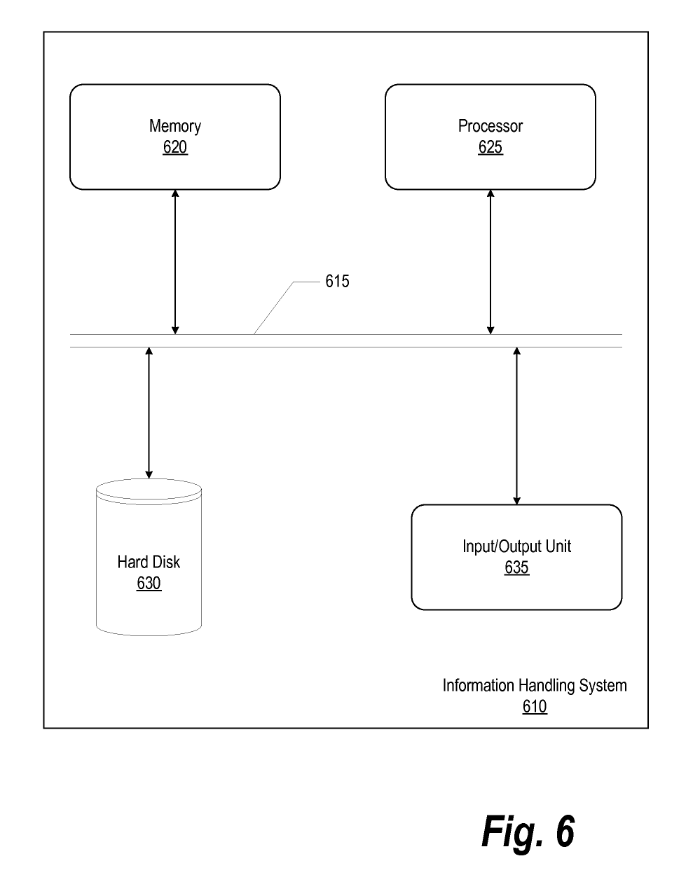

FIG. 6 is a block diagram showing an information handling system operable to relate provider ratings by entities to associations among the entities, in accordance with one embodiment. The information handling system may include software or hardware or both. In the example shown in the figure, information handling system 610 includes memory unit 620, processor 625, hard disk 630, input/output unit 635, and bus 615 to interconnect the various components.

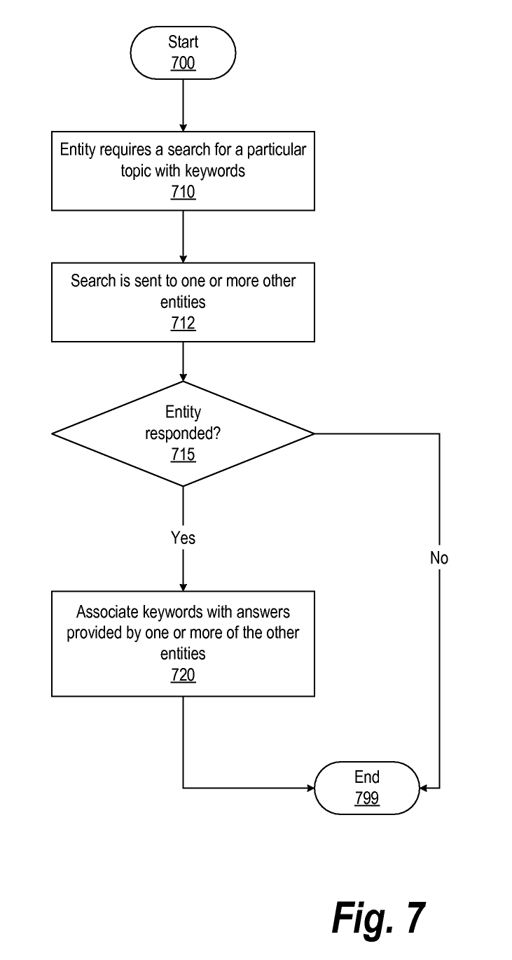

FIG. 7 is a flow diagram illustrating a method for updating keywords in response to keyword searches and subsequent responses, in accordance with one embodiment. The flow diagram describes a general method that may be performed independently of other concepts described herein. Processing begins at 700 whereupon, at block 710, an entity requires a search for a particular topic with keywords. For example, the entity may wish to search for a lawn care provider and the keywords for the desired search may include organic fertilizer.

At block 712, the desired search request is sent to one or more other entities, and at decision 715, a determination is made as to whether an entity has responded to the search request. If no entity has responded, decision 715 branches to 799, where processing ends.

On the other hand, if an entity has responded with a particular answer, decision 715 branches to block 720 where the keywords from the search are associated with the answer provided by the responding entity. For example, if the responding entity named “Ace Lawn” as an answer to the above keyword search/request, the responding entity indirectly provided information that the keywords “organic fertilizer” match “Ace Lawn”.

It should be noted that the above concept can be applied to other situations, such as when a user is searching for a website using keywords, and another user responds with a recommended website.

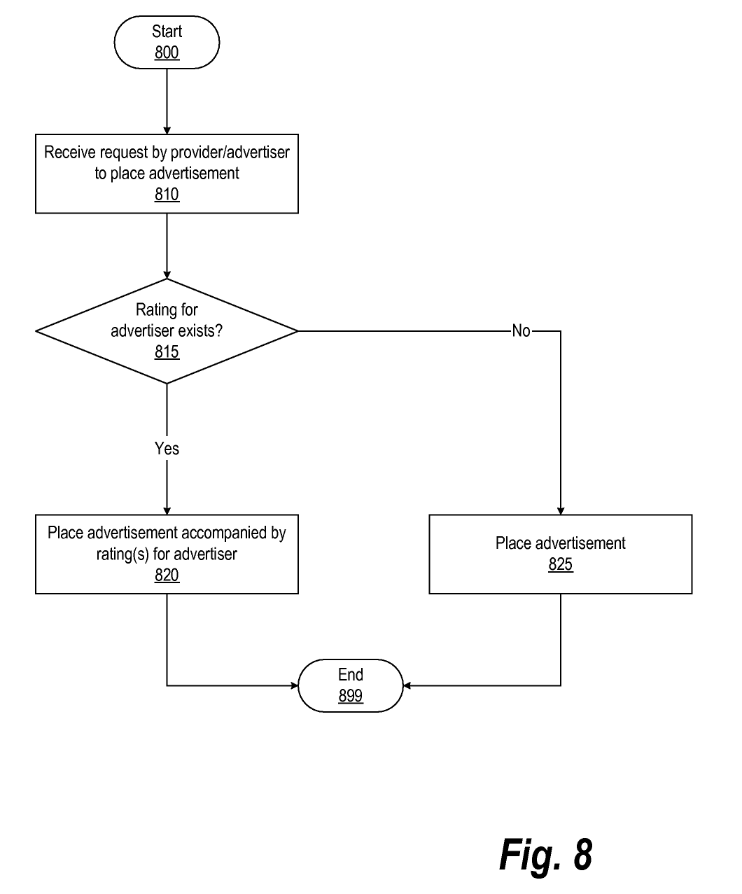

FIG. 8 is a flow diagram illustrating a method for showing advertisements accompanied by corresponding ratings, in accordance with one embodiment. The flow diagram describes a general method that may be performed independently of other concepts described herein. Processing begins at 810 whereupon, at block 810, a request is received by a provider/advertiser to place an advertisement using the system.

At decision 815, a determination is then made as to whether a rating for the adviser exists in the database. If a rating does not exist, decision 815 branches to block 825 where the advertisement is placed (without being accompanied by a rating). Processing subsequently ends at 899.

On the other hand, if a rating for the advertiser exists, decision 820 branches to block 820 where the advertisement is placed accompanied by the rating(s) found in the database for the advertiser.

It should be noted that the above concept can be applied to other situations where ratings for advertisers are available.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for relating entity ratings information to entity association information, the method comprising:
providing association information, the association information being indicative of an association between a plurality of entities;
providing provider ratings by one or more of the entities; and
relating the association information to the provider ratings to determine an entity's provider ratings according to the entity's association information.

2. The method of claim 1 further comprising:
receiving a request by a requesting entity for a provider rating;
searching for existing provider ratings by other entities; and
providing the existing provider ratings to the requesting entity in response to finding existing provider ratings.

3. The method of claim 2 further comprising:
sending the request to one or more recipient entities having a particular association to the requesting entity; and
providing the provider rating to the requesting entity in response to receiving the provider rating from one of the recipient entities.

4. The method of claim 3 further comprising forwarding the request to additional recipient entities having a particular association to one or more of the recipient entities.

5. The method of claim 1 further comprising allowing a requesting entity to view provider ratings by other entities having a particular association to the requesting entity.

6. The method of claim 1 further comprising:
receiving provider rating information from an entity;
authenticating the entity;
storing the provider rating information.

7. An information handling system, the information handling system comprising:
one or more memory units;
one or more input/output devices; and
one or more processors,
wherein the system is operable to:
provide association information, the association information being indicative of an association between a plurality of entities;
provide provider ratings by one or more of the entities; and
relate the association information to the provider ratings to determine an entity's provider ratings according to the entity's association information.

8. The system of claim 7 further being operable to:
receive a request by a requesting entity for a provider rating;
search for existing provider ratings by other entities; and
provide the existing provider ratings to the requesting entity in response to finding existing provider ratings.

9. The system of claim 8 further being operable to:
send the request to one or more recipient entities having a particular association to the requesting entity; and
provide the provider rating to the requesting entity in response to receiving the provider rating from one of the recipient entities.

10. The system of claim 9 further being operable to forward the request to additional recipient entities having a particular association to one or more of the recipient entities.

11. The system of claim 7 further being operable to allow a requesting entity to view provider ratings by other entities having a particular association to the requesting entity.

12. The system of claim 7 further being operable to:
receive provider rating information from an entity;
authenticate the entity;
store the provider rating information.

13. A computer program product stored on a computer operable medium, the computer program product comprising software code being effective to:
provide association information, the association information being indicative of an association between a plurality of entities;
provide provider ratings by one or more of the entities; and
relate the association information to the provider ratings to determine an entity's provider ratings according to the entity's association information.

14. The product of claim 13 wherein the code is further effective to:
receive a request by a requesting entity for a provider rating;
search for existing provider ratings by other entities; and
provide the existing provider ratings to the requesting entity in response to finding existing provider ratings.

15. The product of claim 14 wherein the code is further effective to:
send the request to one or more recipient entities having a particular association to the requesting entity; and
provide the provider rating to the requesting entity in response to receiving the provider rating from one of the recipient entities.

16. The product of claim 15 wherein the code is further effective to forward the request to additional recipient entities having a particular association to one or more of the recipient entities.

17. The product of claim 13 wherein the code is further effective to allow a requesting entity to view provider ratings by other entities having a particular association to the requesting entity.

18. The product of claim 13 wherein the code is further effective to:
receive provider rating information from an entity;
authenticate the entity;
store the provider rating information.
